(19) United States
(12) Patent Application Publication
(10) Pub. No.: US 2026/0354495 A1
(43) Pub. Date: Nov. 12, 2026

(54) AEROSOL-GENERATING DEVICE

(71) Applicant: KT&G CORPORATION, Daejeon (KR)

(72) Inventors: Hwi Kyeong AN, Seoul (KR); Chul Ho JANG, Gyeonggi-do (KR); Heon Jun JEONG, Seoul (KR); Young Bum KWON, Gyeonggi-do (KR)

(73) Assignee: KT&G CORPORATION, Daejeon (KR)

(21) Appl. No.: 19/129,071

(22) PCT Filed: Aug. 23, 2024
(86) PCT No.: PCT/KR2024/012656

§ 371 Date: May 12, 2025

(30) Foreign Application Priority Data
Aug. 29, 2023 (KR) 10-2023-0113738

(51) Int. Cl. A24F 40/57; A24F 40/46; A24F 40/53; H05B 3/18

(52) U.S. Cl. CPC A24F 40/57; A24F 40/46; A24F 40/53; H05B 3/18

(57) ABSTRACT

An aerosol generating device includes a heater structure including an insulating substrate including at least one layer and a plurality of heating elements disposed in the at least one layer, a battery configured to supply power to the plurality of heating elements, and a control unit configured to independently control the power supplied to the plurality of heating elements.

### TECHNICAL FIELD

The present disclosure relates to an aerosol generating device, and more particularly to, an aerosol generating device capable of independently controlling a plurality of heating elements according to the medium length of the aerosol generating substrate while enhancing flavor persistence.

### BACKGROUND ART

Recently, there has been an increasing demand for an alternative method of overcoming disadvantages of general cigarettes. For example, there has been an increasing demand for a method of generating an aerosol by heating a cigarette or an aerosol generating article inside a liquid storage portion (e.g., a cartridge), other than a method of generating an aerosol by burning the cigarette.

Meanwhile, aerosol generating devices of the related art include only one heating element. In contrast, aerosol generating substrates may have different medium lengths according to their types. When aerosol generating substrates are heated with only one heating element despite the different medium lengths, it is impossible to provide an optimal flavor experience. In addition, although some of the aerosol generating devices of the related art include a plurality of heating elements, there is a lack of consideration for a temperature profile capable of sustaining the flavor experience until the latter half of heating.

### DISCLOSURE OF INVENTION

### Technical Problem

The technical problem of the present disclosure is to provide an aerosol generating device capable of independently controlling a plurality of heating elements in order to solve the above problems.

The technical problem of the present disclosure is not limited to what has been described above, and other technical problems may be inferred from the following examples.

### Solution to Problem

According to an aspect, an aerosol generating device includes a heater structure including an insulating substrate including at least one layer and a plurality of heating elements disposed in the at least one layer, a battery configured to supply power to the plurality of heating elements, and a control unit configured to independently control the power supplied to the plurality of heating elements.

### Advantageous Effects of Invention

The aerosol generating device of the present disclosure independently controls a plurality of heating elements according to the type of a medium, and thus a transfer amount of the aerosol generating substrate is increased, thereby providing an optimal flavor experience.

In addition, the aerosol generating device independently controls temperature profiles of a plurality of heating elements in order to maintain the flavor experience until the latter part of heating.

In addition, when a plurality of heating elements are disposed in one layer, the plurality of heating elements may be disposed to be close to each other in order to increase a heating efficiency. In this case, a device failure may be caused by an interference between the plurality of heating elements (e.g., a short circuit). In order to solve this problem, the aerosol generating device of the present disclosure may have some of a plurality of heating elements disposed in a part of an insulating substrate including a plurality of layers such that the plurality of heating elements are not in electrical contact with each other.

In addition, the aerosol generating device may include at least some heating elements configured as surface heating elements, thereby uniformly heating the medium throughout.

In addition, the aerosol generating device uses a graphene element as a surface heating element, and the graphene element heats the medium in a low-resistance and high-current method, and thus a heat generation efficiency may be excellent, and power consumption may be significantly reduced.

The effects of the disclosure are not limited by the contents described above, and more various effects are included in the present specification.

### BRIEF DESCRIPTION OF DRAWINGS

FIG. 1 is a diagram illustrating an aerosol generating device according to an embodiment of the present disclosure.

FIG. 2 is a front perspective view of an aerosol generating device according to an embodiment of the present disclosure.

FIG. 3 is a rear perspective view of an aerosol generating device according to an embodiment of the present disclosure.

FIG. 4 is a rear perspective view of an internal structure of an aerosol generating device including a thermal insulator and a printed circuit board (PCB) according to an embodiment of the present disclosure.

FIG. 5 is a rear perspective view of an internal structure of an aerosol generating device including a battery according to an embodiment of the present disclosure.

FIG. 6 is a rear exploded perspective view of an internal structure according to an embodiment of the present disclosure.

FIG. 7 is a diagram illustrating a heater structure according to an embodiment of the present disclosure.

FIG. 8 is a diagram illustrating a heater structure according to another embodiment of the present disclosure.

FIG. 9 is a diagram illustrating a heater structure according to another embodiment of the present disclosure.

FIG. 10 is a diagram illustrating a heater structure according to another embodiment of the present disclosure.

FIG. 11 is a diagram illustrating a heater structure according to another embodiment of the present disclosure.

FIG. 12 is a diagram illustrating a heater structure according to another embodiment of the present disclosure.

FIG. 13 is a diagram illustrating a temperature profile of a heater structure according to an embodiment of the present disclosure.

FIG. 14 is a diagram illustrating a temperature profile of a heater structure according to another embodiment of the present disclosure.

FIG. 15 is a block diagram of an aerosol generating device according to an embodiment of the present disclosure.

### BEST MODE FOR CARRYING OUT THE INVENTION

According to an aspect, an aerosol generating device includes a heater structure including an insulating substrate including at least one layer and a plurality of heating elements disposed in the at least one layer, a battery configured to supply power to the plurality of heating elements, and a control unit configured to independently control the power supplied to the plurality of heating elements.

The insulating substrate may include a first layer, and the plurality of heating elements may include a first heating element disposed in a first region of the first layer and a second heating element disposed in a second region of the first layer different from the first region.

The first heating element may be a conductive track, and the second heating element may include a first electrode, a second electrode, and a graphene element disposed between the first electrode and the second electrode.

The first heating element may include a first electrode, a second electrode, and a first graphene element disposed between the first electrode and the second electrode, and the second heating element may include a third electrode, a fourth electrode, and a second graphene element disposed between the third electrode and the fourth electrode.

The first electrode, the second electrode, and the first graphene element may be disposed on a first surface of the first layer, and the third electrode, the fourth electrode, and the second graphene element may be disposed in a second surface opposite to the first surface.

The insulating substrate may include a first layer and a second layer, the plurality of heating elements may include a first conductive track and a second conductive track, the first conductive track may be disposed in the first layer, and a part of the second conductive track may be disposed in the first layer, and another part of the second conductive track may be disposed in the second layer.

The plurality of heating elements may further include a first electrode, a second electrode, and a graphene element disposed between the first electrode and the second electrode, the first conductive track and the second conductive track may be disposed in a first region of the insulating substrate, and the first electrode, the second electrode, and the graphene element may be disposed in a second region of the insulating substrate different from the first region.

The plurality of heating elements may include a first heating element and a second heating element that is not electrically in contact with the first heating element, and the control unit may start power supply to the second heating element after a preset time while starting power supply to the first heating element, and when starting power supply to the second heating elements, supply the power to the second heating element based on a second target temperature that is same as a first target temperature of the first heating element.

The plurality of heating elements may include a first heating element and a second heating element that is not electrically in contact with the first heating element, and the control unit may start power supply to the first heating element and the second heating element at a same time, and when power supply is started, set a first temperature profile of the first heating element and a second temperature profile of the second heating element to be different from each other.

The aerosol generating may further include a substrate detection unit configured to identify a type of an aerosol generating substrate accommodated in a cavity.

### Mode for the Invention

Regarding the terms in the various embodiments, the general terms which are currently and widely used are selected in consideration of functions of structural elements in the various embodiments of the present disclosure. However, meanings of the terms may be changed according to intention, a judicial precedence, the appearance of a new technology, and the like. In addition, in certain cases, terms which may be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and may be implemented by hardware components or software components and combinations thereof. In addition, when describing the embodiments of the disclosure, the detailed description of the related known art, which may obscure the subject matter of the embodiments, may be omitted. In addition, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well, unless the context clearly indicates otherwise.

Hereinafter, the present disclosure will now be described more fully with reference to the accompanying drawings, in which exemplary embodiments of the present disclosure are shown such that one of ordinary skill in the art may easily work the present disclosure. However, the present disclosure may be implemented in various different forms, and is not limited to the embodiments described herein.

The same or similar components will be assigned the same reference numerals regardless of the reference numerals in the drawings, and the same descriptions thereof will be omitted.

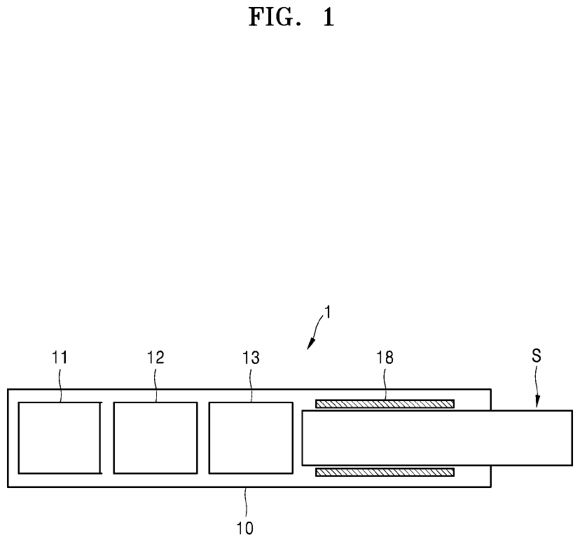

FIG. 1 illustrates an aerosol generating system including an aerosol generating device 1 and an aerosol generating article S according to embodiments of the present disclosure.

Referring to FIG. 1, the aerosol generating device 1 may include at least one of a power source 11, a control unit 12, a sensor 13, or a heater 18. At least one of the power source 11, the control unit 12, the sensor 13, and the heater 18 may be disposed inside a body 10 of the aerosol generating device 1. The body 10 may provide a space opened upward to allow an aerosol generating article S to be inserted into the space. The aerosol generating article S may be referred to as a stick, a cigarette, etc., but is not limited thereto. The aerosol generating article S may include an aerosol generating material and may generate an aerosol by the aerosol generating device 1. The aerosol generating system may include the aerosol generating device 1 and the aerosol generating article S, but is not limited thereto.

The opened space of the aerosol generating device 1 may be referred to as an insertion space. The insertion space may be formed by being recessed toward the interior of the body 10 to a certain depth so that at least a part of the aerosol generating article S may be inserted into the insertion space. The depth of the insertion space may correspond to a length of a region of the aerosol generating article S including an aerosol generating material and/or a medium. A lower end of the aerosol generating article S may be inserted into the body 10, and an upper end of the aerosol generating article S may protrude to the outside of the body 10. A user may inhale air by holding, in the mouth, the upper end of the aerosol generating article S exposed to the outside.

The heater 18 may heat the aerosol generating article S. When the aerosol generating article S is heated, an aerosol may be generated. That is, the heater 18 may generate an aerosol by heating the aerosol generating article S. The heater 18 may extend long upward around the space into which the aerosol generating article S is inserted. For example, the heater 18 may be in the form of a tube including a hollow inside. The heater 18 may be disposed around the insertion space. The heater 18 may be disposed to surround at least a part of the insertion space. The heater 18 may heat the insertion space or the aerosol generating article S inserted into the insertion space. The heater 18 may include an electrically resistive heater and/or an induction heater.

For example, referring to FIG. 1, the heater 18 may be a resistive heater. For example, the heater 18 may include an electrically conductive track, and be heated as a current flows through the electrically conductive track. The heater 18 may be electrically connected to the power source 11. The power source 11 may supply power to the heater 18. The heater 18 may directly generate heat by receiving a current from the power source 11. The heater 18 may be a hollow shape heater disposed to surround at least a part of the aerosol generating article S inserted into the insertion space to heat the outside of the inserted aerosol generating article S, or may be a heater in the shape of a needle, rod, or tube inserted into the aerosol generating article S inserted into the insertion space to heat the inside.

For example, the heater 18 may be a multi-heater. The heater 18 may include a first heater and a second heater. The first heater and the second heater may be disposed side by side in a longitudinal direction. The first heater and the second heater may be heated sequentially or simultaneously.

The power supply 11 may supply power such that the components of the aerosol generating device 1 operate. The power source 11 may be referred to as a battery. The power supply 11 may supply power to at least one of the control unit 12, the sensor 13, or the heater 18. When the aerosol generating device 1 includes the electrically conductive track, the power source 11 may supply power to the electrically conductive track.

The control unit 12 may control overall operations of the aerosol generating device 1. The control unit 12 may be mounted on a printed circuit board (PCB). The control unit 12 may control an operation of at least one of the power source 11 or the sensor 13. The control unit 12 may control the operation of the heater 18. The control unit 12 may control operations of a display, a motor, etc. installed in the aerosol generating device 1. The control unit 12 may check a state of each of the components of the aerosol generating device 1 to determine whether the aerosol generating device 1 is in an operable state.

The control unit 12 may analyze a result detected by the sensor 13 and control processes to be performed subsequently. For example, the control unit 12 may control the power supplied to the heater 18 such that the operation of the heater 18 starts or ends based on the result detected by the sensor 13. For example, the control unit 12 may control an amount of power supplied to the heater 18 and a time for which the power is supplied to the heater 18 such that the heater 18 may be heated to a certain temperature or maintained at an appropriate temperature based on the result detected by the sensor 13.

The sensor 13 may include at least one of a temperature sensor, a puff sensor, or an insertion detection sensor. For example, the sensor 13 may sense at least one of the temperature of the heater 18, the temperature of the power source 11, or the temperature inside and outside the body 10. For example, the sensor 13 may sense a puff by the user. For example, the sensor 13 may sense whether the aerosol generating article S has been inserted into the insertion space.

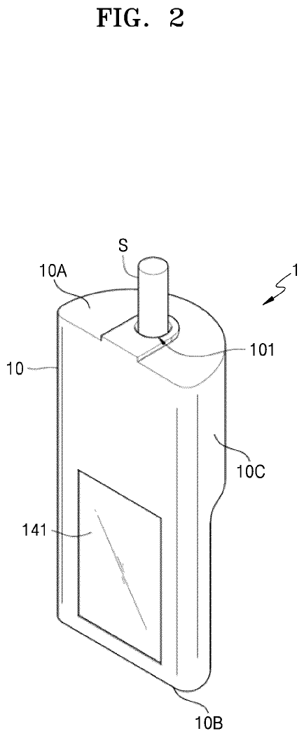

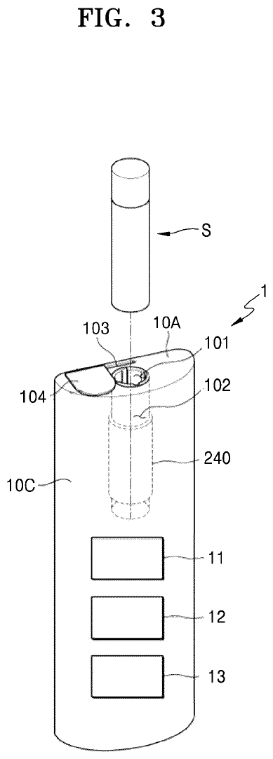

FIG. 2 is a front perspective view of an aerosol generating device according to an embodiment of the present disclosure. FIG. 3 is a rear perspective view of an aerosol generating device according to an embodiment of the present disclosure.

Referring to FIG. 2, the aerosol generating device 1 according to an embodiment of the present disclosure may include at least one of the power source 11, the control unit 12, or the sensor 13. At least one of the power source 11, the control unit 12, or the sensor 13 may be disposed inside the body 10 of the aerosol generating device 1. The characteristics of the power source 11, the control unit 12, and the sensor 13 described above with reference to FIGS. 1 and 2 may be equally applied to the power source 11, the control unit 12, and the sensor 13.

The body 10 may form the overall appearance of the aerosol generating device 1, and include an inner space in which components of the aerosol generating device 1 may be disposed. The drawings illustrate only an embodiment in which the body 10 has a semicircular cross section as a whole, but the shape of the body 10 is not limited thereto. For example, the body 10 may have a cylindrical shape or a polygonal column shape as a whole.

The body 10 may include a first body surface 10A (e.g., a body upper surface), a second body surface 10B (e.g., a body lower surface) opposite the first body surface 10A, and at least one third body surface 10C (e.g., a body side surface) between the first body surface 10A and the second body surface 10B.

Referring to FIG. 3, the body 10 may have an insertion space 102 formed therein. The insertion space 102 may be formed on an upper portion of the body 10. The insertion space 102 may be opened upward. The insertion space 102 may have a cylindrical shape extending vertically but is not limited thereto. At least a part of the aerosol generating article S may be inserted into the body 10 through an opening 101 in an upper side of the insertion space 102. A depth of the insertion space 102 may correspond to a length of a region of the aerosol generating article S including an aerosol generating material and/or a medium.

A heater 240 may surround at least a part of the outside of the insertion space 102. The heater 240 may extend vertically along the insertion space 102. For example, the heater 240 may be a cylindrical electric resistive heater surrounding at least a part of the insertion space 102. The heater 240 may heat the outside of the aerosol generating article S accommodated in the insertion space 102. At least one region of the aerosol generating article S accommodated in the insertion space 102 may be heated by the heater 240, and vaporized particles generated by heating the aerosol generating article S and air introduced into the inner space of the body 10 through the opening 101 may be mixed to generate an aerosol. The heater 240 may be a configuration corresponding to the heater 18 of FIG. 1.

A display 141 may be disposed on one side of the body 10. At least a part of the display 141 may be exposed to the outside of the body 10.

The display 141 may provide a variety of visual information to a user. The display 141 may include a display panel and/or a touch panel. The display 141 may include a cover glass.

The cover glass may form the appearance of the aerosol generating device 1 together with the body 10. The cover glass may be in contact with a part of a user's body. The cover glass may protect the display panel and/or the touch panel from an external impact.

The display panel may be disposed in a direction toward the inside of the body 10 from the cover glass. The display panel may be disposed parallel to the cover glass.

The touch panel may detect a touch corresponding to the contact of an object. For example, the touch panel may detect a touch corresponding to the contact of a part of the user's body. The touch panel may receive an input of the user.

A cover 104 may be provided on the upper side of the body 10. The cover 104 may have a shape corresponding to the shape of the opening 101 of the body 10. For example, the opening 101 of the body 10 may be circular, and the cover 104 may be circular with a larger diameter than the diameter of the opening 101.

The cover 104 may be movably connected to a guide 103 formed in the body 10. The cover 104 may move along the guide 103. For example, the guide 103 may be a groove formed in one surface of the body 10, and the cover 104 may include a protrusion that slides while being inserted into the groove of the body 10. For example, the guide 103 may be a protrusion protruding from one surface of the body 10, and the cover 104 may include a groove inserted into the protrusion to be slid along the protrusion.

The cover 104 may open and close the opening 101 of the body 10 by moving along the guide 103. For example, the cover 104 may close the opening 101 at a first position and open the opening 101 at a second position. A position of the cover 104 may be manually moved by the user. In addition, a driving device may be provided in the aerosol generating device 1 to move the position of the cover 104.

The body 10 may include a connection terminal (not shown). The connection terminal may include a connector through which the aerosol generating device 1 may be physically connected to an external electronic device. For example, the connection terminal may include at least one of an HDMI connector, a USB connector, an SD card connector, or an audio connector (e.g., a headphone connector) or a combination thereof.

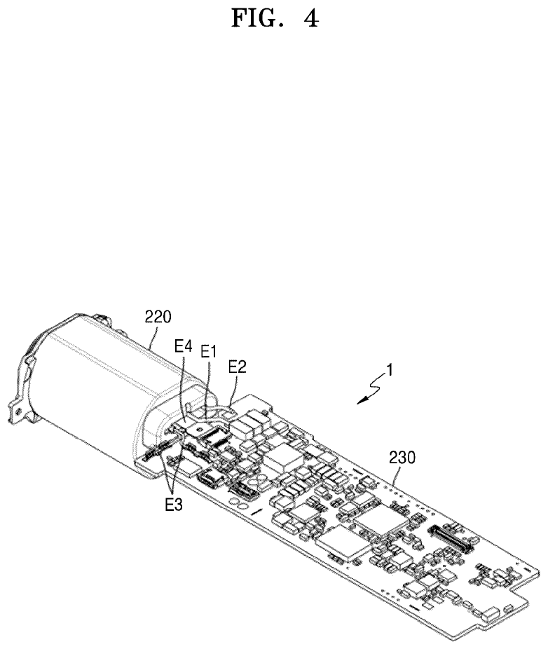

FIG. 4 is a rear perspective view of an internal structure of an aerosol generating device including a thermal insulator and a PCB according to an embodiment of the present disclosure.

Referring to FIG. 4, the aerosol generating device 1 may include a thermal insulator 220. The thermal insulator 220 may be configured to thermally insulate the heater 240. The thermal insulator 220 may include the heater 240 therein. The thermal insulator 220 may include an antenna (not shown) (e.g., an LCD antenna) therein.

The thermal insulator 220 is disposed to surround the heater 240 to seal the heater 240 and prevent droplets generated during an aerosol generating process through the heater 240 from leaking to the outside, thereby preventing malfunction or damage of the components of the aerosol generating device 1 due to the droplets.

The thermal insulator 220 seals the heater 240 to prevent heat generated by the heater 240 from being transmitted to an outer circumferential surface of the body 10, thereby preventing high-temperature heat from being transmitted to the user's body (e.g., palm) holding the body 10 even when the temperature of the heater 240 is maintained at a high temperature.

The aerosol generating device 1 may include a PCB 230. For example, the PCB 230 may include at least one of the control unit 12, the sensor 13, a memory (17 in FIG. 15), or a communication unit (16 in FIG. 15), or a combination thereof.

The aerosol generating device 1 may include a plurality of electrical lines E1, E2, E3, and E4. For example, the first electrical line El may be configured to connect the heater 240 to a temperature sensor (131 in FIG. 15). The second electrical line E2 may be configured to connect the heater 240 to the PCB 230. At least one third electrical line E3 may be configured to connect at least one sensor to the PCB 230. The fourth electrical line E4 may be configured to connect the heater housing of the heater 240 to the PCB 230. The fourth electrical line E4 may include a flexible PCB.

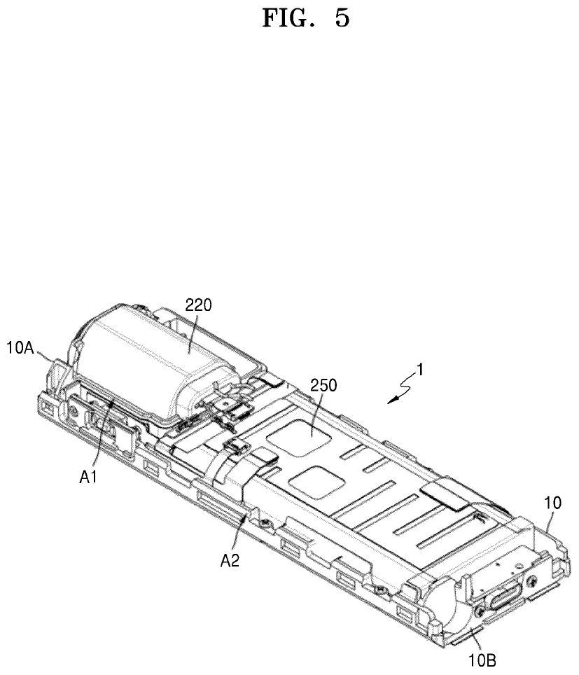

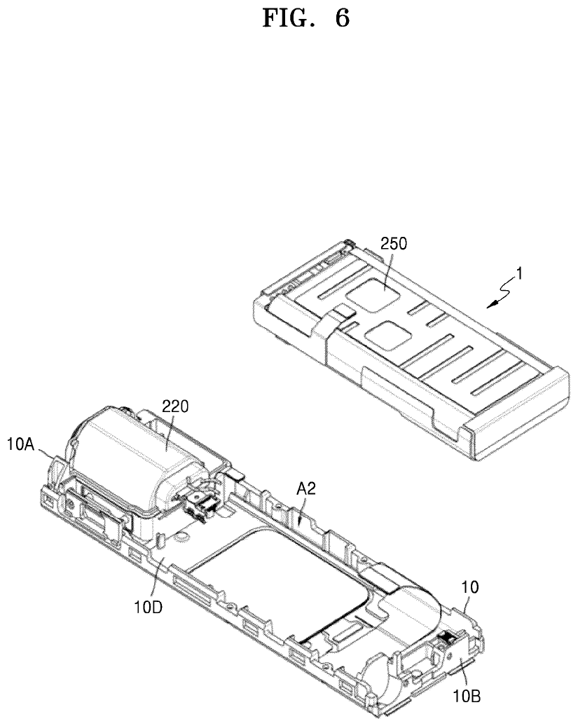

FIG. 5 is a rear perspective view of an internal structure of an aerosol generating device including a battery according to an embodiment of the present disclosure. FIG. 6 is a rear exploded perspective view of an internal structure according to an embodiment of the present disclosure.

Referring to FIGS. 5 and 6, the body 10 of the aerosol generating device 1 may include a first portion A1. The first portion A1 may include a part adjacent to the first body surface 10A of the body 10. The body 10 may include a second portion A2. The second portion A2 may be at least partially different from the first portion A1. The second portion A2 may include a part adjacent to the second body surface 10B of the body 10.

The body 10 may include a wall. The wall may separate the first portion A1 from the second portion A2. The wall may extend from an inner surface 10D in a direction perpendicular to the inner surface 10D of the body 10. The wall may extend across the inner surface 10D in a direction (e.g., a width direction of the body 10) intersecting a vertical direction (e.g., a thickness direction of the body 10) of the inner surface 10D of the body 10. The direction may intersect a direction (e.g., a longitudinal direction of the body 10) from the first body surface 10A to the second body surface 10B of the body 10.

A power source 250 may be disposed in the second portion A2 of the body 10. The power source 250 may be a configuration corresponding to the power source 11 of FIG. 1. The power supply 250 may include a pouch type battery. The power source 250 may be disposed adjacent to the PCB 230. For example, the power supply 250 may be disposed on one side of the inner surface 10D of the body 10, and the PCB 230 may be disposed on the other side of the power supply 250 opposite to one side of the inner surface 10D. However, the arrangement of the PCB 230 and the power source 250 is not limited thereto.

The heater 240 may be disposed in the first portion A1 of the body 10.

The thermal insulator 220 may thermally insulate the heater 240. The thermal insulator 220 may be disposed in the first portion A1 of the body 10. The thermal insulator 220 may surround the heater 240.

The aerosol generating device 1 may include a buffer structure (not shown). The buffer structure may be configured to buffer the power source 250. The buffer structure may be disposed in at least a part of the inner surface 10D of the second portion A2 of the body 10. The buffer structure may reduce or prevent an impact applied to the power supply 250 when an external impact is applied to the aerosol generating device 1.

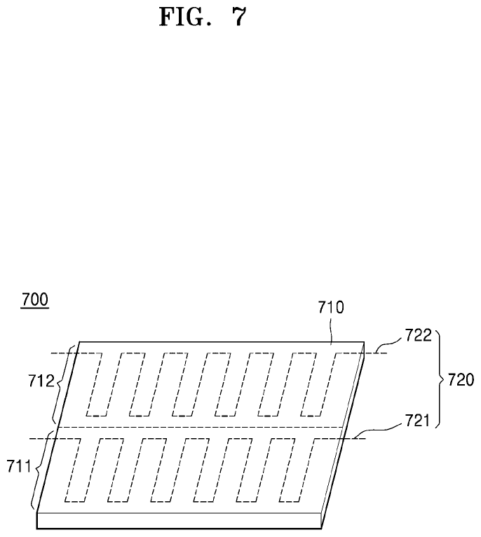

FIG. 7 is a diagram illustrating a heater structure according to an embodiment of the present disclosure.

Referring to FIG. 7, a heater structure 700 of the present disclosure includes an insulating substrate 710 including at least one layer and a plurality of heating elements 720 disposed on the at least one layer. The heater structure 700 may be a configuration corresponding to the heater 18 of FIGS. 1 to 6.

The insulating substrate 710 may perform an electrical insulating function, and may include a flexible material. The insulating substrate 710 may be a green sheet including a ceramic synthetic material. Here, the ceramic may include a compound such as alumina, zircona, etc., but is not limited thereto. Alternatively, the insulating substrate 710 may include paper, glass, ceramic, anodized metal, coated metal, or polyimide.

The plurality of heating elements 720 may include a first heating element 721 and a second heating element 722. However, the number of the plurality of heating elements 720 is not limited thereto, and additional heating elements may be further included according to embodiments.

The first heating element 721 and the second heating element 722 may be disposed on the insulating substrate 710. According to an embodiment, the first heating element 721 and the second heating element 722 may be embedded in the insulating substrate 710 or may be stacked on the insulating substrate 710. In addition, the first heating element 721 and the second heating element 722 may be patterned on the insulating substrate 710.

According to an embodiment, at least one coating layer may be additionally formed to protect the first heating element 721 and the second heating element 722. The coating layer may surround the first heating element 721 and the second heating element 722. The coating layer may include a heat resistant composition. For example, the coating layer may include a glass film coating layer, a Teflon coating layer, and a coating layer of a dermolon coating layer, but is not limited thereto. In addition, the coating layer may contain a composition for preventing contamination. For example, the coating layer may further include an antifouling coating layer. The antifouling coating layer may be located in the outermost side of the heater structure 700 to protect the heater structure 700 from contaminants. The antifouling coating layer may have a thickness smaller than that of a heat resistant coating layer.

The plurality of heating elements 720 may be disposed on one surface of the insulating substrate 710, or may be separately disposed on both surfaces of the insulating substrate 710. FIG. 7 illustrates an example in which the plurality of heating elements 720 are disposed on one surface of the insulating substrate 710, but according to an embodiment, the first heating element 721 may be disposed on a first surface of the insulating substrate 710, and the second heating element 722 may be disposed on a second surface of the insulating substrate 710.

As shown in FIG. 7, in an embodiment in which the plurality of heating elements 720 are disposed on one surface of the insulating substrate 710, the first heating element 721 may be disposed in a first region 711 of the insulating substrate 710, and the second heating element 722 may be disposed in a second region 712 different from the first region 711. The first region 711 and the second region 712 may not overlap each other. The first region 711 may refer to a region in one direction with respect to a center line of the insulating substrate 710 in a longitudinal direction. The second region 712 may refer to a region in the other direction with respect to the center line of the insulating substrate 710 in the longitudinal direction. According to an embodiment, the first heating element 721 and the second heating element 722 may be disposed in the same region, and a part of the second heating element 722 may be disposed on an n+1 layer (n is a natural number) layer so as not to be in electrical contact with the first heating element 721. The plurality of heating elements 720 may be configured as electrically resistive heaters. For example, the electrically resistive heater may be at least one of a conductive track or a graphene heating element. FIG. 7 illustrates an example in which all of the plurality of heating elements 720 are configured as conductive tracks, but according to an embodiment, the first heating element 721 may be configured as a graphene heating element, and the second heating element 722 may be configured as a conductive track. In addition, both the first heating element 721 and the second heating element 722 may be configured as graphene heating elements.

The conductive track includes an electrically resistive material. For example, the conductive track may include a metallic material. As another example, the conductive track may include an electrically conductive ceramic material, carbon, a metal alloy, or a synthetic material of a ceramic material and a metal. When both the first heating element 721 and the second heating element 722 are configured as conductive tracks, each of the first heating element 721 and the second heating element 722 may be selectively manufactured from the same material group, for example, tungsten, gold, platinum, silver, copper, nickel palladium, or a combination thereof. At this time, even when the constituent material of the first heating element 721 and the constituent material of the second heating element 722 are the same, resistance values of the first heating element 721 and the second heating element 722 may be different from each other due to a difference in lengths, widths, or patterns of conductive tracks.

The conductive tracks may be formed in various patterns such as a curve type, a mesh type, etc. For example, at least a part of a first conductive track may include a first pattern region in which an extending direction is regularly changed. Likewise, at least a part of a second conductive track may include a second pattern region in which an extending direction is regularly changed. Patterns or shapes of the first conductive track and the second conductive track may be variously implemented in a curved shape or an atypical shape instead of an angled shape. For example, the first conductive track and the second conductive track may be implemented in a “U” shape or a hairpin shape. In an embodiment in which the first conductive track and the second conductive track are spaced apart from each other as shown in FIG. 7, a distance between the patterns of each conductive track may be at least 0.5 mm. In addition, the distance between the first conductive track and the second conductive track may be at least 2.5 mm. However, this is only an example value, and the above-described value may be changed due to a change in parameters such as a width and a thickness of each conductive track.

The first conductive track and the second conductive track may be formed on the insulating substrate 710 in paths of the same pattern having the same ratio of sizes. However, the disclosure is not limited thereto, and the first conductive track and the second conductive track may be formed on the insulating substrate in paths of different patterns having different ratios of sizes.

The first conductive track and the second conductive track may be electrically conductive elements having the same thermal coefficient resistance (TCR) and/or the same resistance value. For example, each of the first conductive track and the second conductive track may have a TCR between 1200 ppm/°C and 1800 ppm/°C. Alternatively, each of the first conductive track and the second conductive track may have a TCR between 3500 ppm/°C and 41000 ppm/°C. In addition, each of the first conductive track and the second conductive track may have a resistance value between 0.722 and 0.8522 at room temperature of 25 °C. Alternatively, each of the first conductive track and the second conductive track may have resistance values between 12 Ω and 14 Ω at room temperature of 25 °C. According to an embodiment, the first conductive track and the second conductive track may be electrically conductive elements having different TCRs and/or different resistance values.

The graphene heating element may include a plurality of electrodes and a graphene element disposed between the plurality of electrodes. The graphene element may be a polymer carbon allotrope in which carbon atoms are connected to each other in a hexagonal honeycomb shape to form a two-dimensional planar structure. The graphene element may have excellent electrical conductivity in the form of a thin film. In addition, the graphene element may surface-heat an aerosol generating substrate.

The plurality of electrodes may include electrically conductive materials. For example, the plurality of electrodes may include stainless steel, tungsten, gold, platinum, silver, copper, nickel, chromium, palladium, or a combination thereof. When power is applied between the plurality of electrodes, heat may be generated in an atomic layer of the graphene element.

The first heating element 721 and the second heating element 722 are connected to a battery to receive power. The battery may refer to the power source 11 of FIGS. 1 to 6. According to an embodiment, a power conversion unit for supplying AC power may be further disposed between the battery and the plurality of heating elements 720. In an embodiment, the first heating element 721 and the second heating element 722 may receive power from the same battery. For example, the first heating element 721 and the second heating element 722 may be connected in parallel with the battery to receive power from the battery. To this end, the aerosol generating device 1 of the present disclosure may include at least one switching element between the battery and the plurality of heating elements 720. In another embodiment, the first heating element 721 and the second heating element 722 may receive power from different batteries. For example, the first heating element 721 may receive power from a first battery connected to the first heating element 721, and the second heating element 722 may receive power from a second battery connected to the second heating element 722.

The power supplied to the plurality of heating elements 720 may be controlled by a microprocessor. The microprocessor may be the control unit 12 of FIGS. 1 to 6. The control unit 12 may independently control the power supplied to the plurality of heating elements 720 by controlling the battery. The control unit 12 may identify a type of an aerosol generating substrate and supply the power to the plurality of heating elements 720 according to a temperature profile corresponding to the identified aerosol generating substrate. The aerosol generating substrate may be a configuration corresponding to the aerosol generating article S of FIGS. 1 to 6. The control unit 120 may supply the power to the plurality of heating elements 720 based on the length of a medium according to the aerosol generating substrate. A first temperature profile for controlling the first heating element 721 and a second temperature profile for controlling the second heating element 722 may be stored in the memory 17. Information about a target temperature over time may be stored in each of the first temperature profile and the second temperature profile. The aerosol generating device 1 of the present disclosure may include a separate temperature sensor 131 and measure the temperature of each of the plurality of heating elements 720 by using the temperature sensor 131. In addition, the control unit 12 heats the first heating element 721 based on the first temperature profile and heats the second heating element 722 based on the second temperature profile.

In an embodiment, the control unit 12 may set a time of power supply start of the first heating element 721 and a time of power supply start of the second heating element 722 to be different from each other. For example, while starting power supply to the first heating element 721, the control unit 12 may start power supply to the second heating element 722 after a preset time. When the control unit 12 starts power supply to the second heating element 722, the control unit 12 may start power supply to the second heating element 722 based on a second target temperature that is the same as a first target temperature of the first heating element 721.

In another embodiment, the control unit 12 may set the time of power supply start of the first heating element 721 and the time of power supply start of the second heating element 722 to be the same as each other. For example, when the control unit 12 starts power supply to the first heating element 721 and the second heating element 722 at the same time. In this case, the control unit 12 may set the first temperature profile of the first heating element 721 and the second temperature profile of the second heating element 722 to be different from each other.

The descriptions of the first heating element 721, the second heating element 722, the insulating substrate 710, the temperature profiles given above may also be applied to the following descriptions. Hereinafter, the redundant descriptions will be omitted.

FIG. 8 is a diagram illustrating a heater structure according to another embodiment of the present disclosure.

Referring to FIG. 8, a heater structure 800 includes an insulating substrate 810 and a plurality of heating elements 821 and 822. The heater structure 800 may be a configuration corresponding to the heater 18 of FIGS. 1 to 6.

The insulating substrate 810 may include one layer (first layer), and may perform an electrical insulating function. According to an embodiment, the insulating substrate 810 may simultaneously perform a thermally conductive function of conducting heat emitted from the plurality of heating elements 821 and 822.

The plurality of heating elements 821 and 822 may include a first heating element 821 and a second heating element 822. The first heating element 821 may be disposed in a first region 811 of a first layer, and the second heating element 822 may be disposed in a second region 812 different from the first region 811.

The first region 811 may mean a region in one direction with respect to a center line of the first layer in a longitudinal direction. The second region 812 may mean a region in the other direction with respect to the center line of the first layer in the longitudinal direction.

The first heating element 821 may be a graphene heating element, and the second heating element 822 may be a conductive track.

The graphene heating element may include a first electrode 821a, a second electrode 821b, and a graphene element 821c between the first electrode 821a and the second electrode 821b. The first electrode 821a and the second electrode 821b may include electrically conductive materials, and may be connected to a battery. As power is supplied to the first electrode 821a and the second electrode 821b, the graphene element 821c may generate heat to heat an aerosol generating substrate.

The conductive track may include an electrically resistive material, and both ends of the conductive track may be electrically connected to the battery. The conductive track may generate heat by the power supplied from the battery to heat the aerosol generating substrate.

The heater structure 800 may be rolled such that both ends of the conductive track and both electrodes of the graphene heating element are close to each other. The rolled heater structure 800 may surround the aerosol generating substrate. The aerosol generating substrate may be inserted from the conductive track toward the graphene heating element, and a control unit may independently control the conductive track and the graphene heating element.

Meanwhile, the length of a tobacco medium may be different depending on a type of the aerosol generating substrate. According to the length of the tobacco medium, the tobacco medium may be disposed beyond the conductive track or may be disposed inside the conductive track. In contrast, the graphene heating element disposed in the first region 711 is disposed in a region in contact with a lower portion of the aerosol generating substrate, and thus has little relationship with the medium length. In other words, the tobacco medium in contact with the graphene heating element needs to be continuously heated regardless of the length of the tobacco medium, and the graphene heating element is disposed in the lower portion of the aerosol generating substrate in the present disclosure, thereby increasing heating efficiency due to surface heat generation and reducing power consumption.

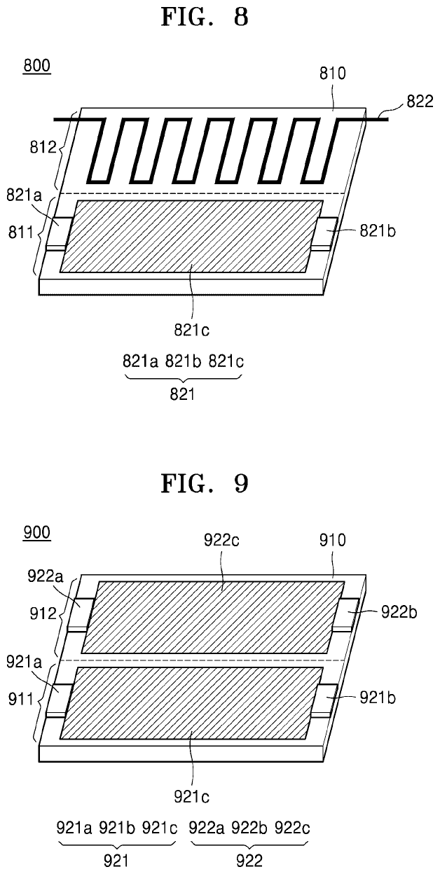

FIG. 9 is a diagram illustrating a heater structure according to another embodiment of the present disclosure.

Referring to FIG. 9, a heater structure 900 includes an insulating substrate 910 and a plurality of heating elements 921 and 922. The heater structure 900 may be a configuration corresponding to the heater 18 of FIGS. 1 to 6. FIG. 9 is different from FIG. 8 in that all of the plurality of heating elements 921 and 922 are configured as graphene heating elements.

The insulating substrate 910 includes one layer (first layer), and may perform an electrical insulating function. According to an embodiment, the insulating substrate 910 may simultaneously perform a thermally conductive function of conducting heat emitted from the plurality of heating elements 921 and 922.

The plurality of heating elements 921 and 922 may include a first heating element 921 and a second heating element 922. The first heating element 921 may be disposed in a first region 911 of a first layer, and the second heating element 922 may be disposed in a second region 912 different from the first region 911.

The first region 911 may mean a region in one direction with respect to a center line of the first layer in a longitudinal direction. The second region 912 may mean a region in the other direction with respect to the center line of the first layer in the longitudinal direction.

The first heating element 921 and the second heating element 922 may be a first graphene heating element and a second graphene heating element, respectively.

The first graphene heating element may include a first electrode 921a, a second electrode 921b, and a first graphene element 921c between the first electrode 921a and the second electrode 921b. The first electrode 921a and the second electrode 921b may include electrically conductive materials, and may be connected to a battery. As power is supplied to the first electrode 921a and the second electrode 921b, the first graphene element 921c may generate heat to heat an aerosol generating substrate.

The second graphene heating element may include a third electrode 922a, a fourth electrode 922b, and a second graphene element 922c between the third electrode 922a and the fourth electrode 922b. The third electrode 922a and the fourth electrode 922b may include electrically conductive materials, and may be connected to the battery. As power is supplied to the third electrode 922a and the fourth electrode 922b, the second graphene element 922c may generate heat to heat the aerosol generating substrate.

The heater structure 900 may be rolled such that both electrodes included in each of the first graphene heating element and the second graphene heating element are close to each other. The rolled heater structure 900 may surround the aerosol generating substrate. The aerosol generating substrate may be inserted from the second graphene heating element toward the first graphene heating element, and a control unit may independently control the first graphene heating element and the second graphene heating element.

On the other hand, all of the heating elements 921 and 922 are configured as the graphene heating elements, and thus the aerosol generating device 1 of the present disclosure may increase a transfer amount of aerosols by surface heating while heating the aerosol generating substrate at low power.

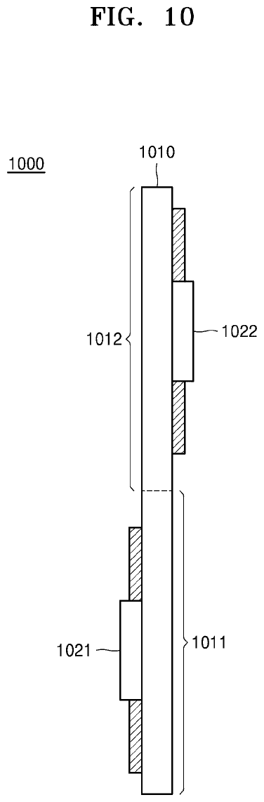

FIG. 10 is a diagram illustrating a heater structure according to another embodiment of the present disclosure.

Referring to FIG. 10, a heater structure 1000 includes an insulating substrate 1010 and a plurality of heating elements 1021 and 1022. The heater structure 1000 may be a configuration corresponding to the heater 18 of FIGS. 1 to 6. As shown in FIG. 9, all of the plurality of heating elements 1021 and 1022 are configured as graphene heating elements. FIG. 10 is different from FIG. 9 in that the graphene heating elements are separately disposed on both surfaces of an insulating substrate 1010.

The insulating substrate 1010 includes one layer (first layer), and may perform an electrical insulating function. According to an embodiment, the insulating substrate 1010 may simultaneously perform a thermally conductive function of conducting heat emitted from the plurality of heating elements 1021 and 1022.

The plurality of heating elements 1021 and 1022 may include a first heating element 1021 and a second heating element 1022. The first heating element 1021 and the second heating element 1022 may be a first graphene heating element and a second graphene heating element, respectively. Each of the first graphene heating element and the second graphene heating element may include a plurality of electrodes and a graphene element between the plurality of electrodes.

The first heating element 1021 may be disposed on a first surface of a first layer, and the second heating element 1022 may be disposed on a second surface opposite to the first surface. The first heating element 1021 and the second heating element 1022 may be disposed not to overlap each other. In other words, a first region 1011 heated by the first heating element 1021 and a second region 1012 heated by the second heating element 1022 may not overlap each other.

The heater structure 1000 may be rolled such that both electrodes included in each of the first graphene heating element and the second graphene heating element are close to each other. The rolled heater structure 1000 may be inserted into an aerosol generating substrate or may surround the aerosol generating substrate. The aerosol generating substrate may be inserted from the second graphene heating element toward the first graphene heating element, and a control unit may independently control the first graphene heating element and the second graphene heating element.

On the other hand, all of the heating elements 1021 and 1022 are configured as the graphene heating elements, and thus the aerosol generating device 1 of the present disclosure may increase a transfer amount of aerosols by surface heating while heating the aerosol generating substrate at low power.

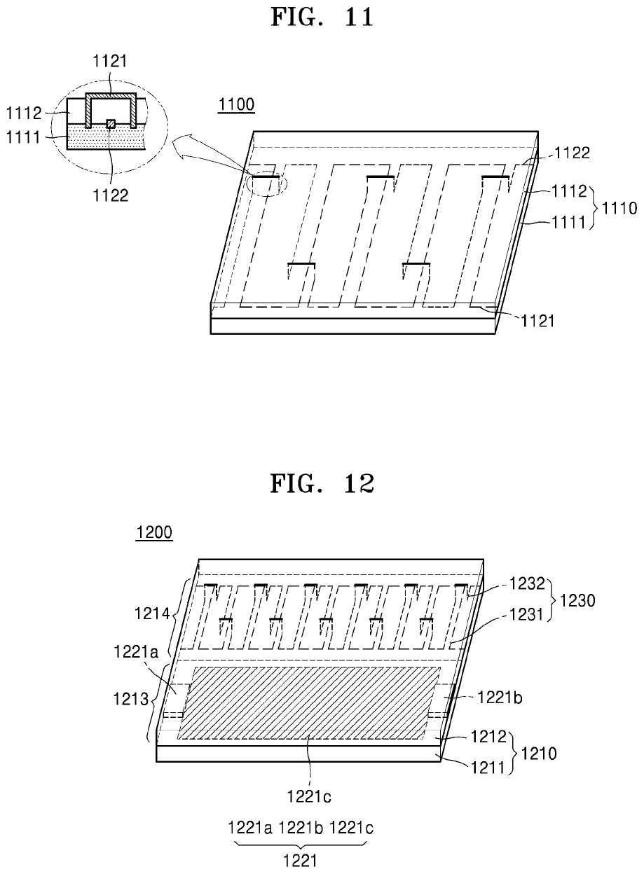

FIG. 11 is a diagram illustrating a heater structure according to another embodiment of the present disclosure.

Referring to FIG. 11, a heater structure 1100 includes an insulating substrate 1110 including a plurality of layers 1111 and 1112, and a plurality of heating elements 1121 and 1122. The heater structure 1100 may be a configuration corresponding to the heater 18 of FIGS. 1 to 6. FIG. 11 is different from FIGS. 7 to 10 in that the insulating substrate 1110 includes the plurality of layers and some of the plurality of heating elements 1121 and 1122 are disposed by changing the plurality of layers so that the plurality of heating elements 1121 and 1122 do not overlap each other.

The insulating substrate 1110 includes a first layer 1111 and a second layer 1112, and may perform an electrical insulating function. According to an embodiment, the insulating substrate 1110 may simultaneously perform a thermally conductive function of conducting heat emitted from the plurality of heating elements 1121 and 1122.

The plurality of heating elements 1121 and 1122 may include a first heating element 1121 and a second heating element 1122. Both the first heating element 1121 and the second heating element 1122 may be conductive tracks. In an embodiment, the first heating element 1121 may be a first conductive track, and the second heating element 1122 may be a second conductive track. Each of the first conductive track and the second conductive track includes an electrically resistive material, and both ends thereof may be electrically connected to a battery. Each of the first conductive track and the second conductive track may be heated by power supplied from the battery to heat an aerosol generating substrate.

The first heating element 1121 may be disposed in the first layer 1111. The second heating element 1122 may be disposed in the first layer 1111, and a part thereof may be disposed in the second layer 1112 so that the second heating element 1122 does not electrically contact the first heating element 1121. More specifically, most of the second heating element 1122 may be disposed in the first layer 1111, and a part thereof may penetrate the second layer 1112 and be disposed on the second layer 1112. To this end, the second layer 1112 may include a via hole through which the second heating element 1122 penetrates.

Most of the second heating element 1122 is disposed in the first layer 1111, which may be referred to as a first portion. In addition, the second heating element 1122 may include a second portion penetrating the second layer 1112 and a third portion disposed on the second layer 1112. The first portion of the second heating element 1122 may be disposed to be spaced apart from the first heating element 1121 by a certain distance. For example, the first portion of the second heating element 1122 may be disposed parallel to the first heating element 1121. The second portion of the second heating element 1122 may penetrate the second layer 1112. According to an embodiment, the second portion of the second heating element 1122 may be buried in the second layer 1112. The third portion of the second heating element 1122 may be disposed in the second layer 1112 and may intersect the first heating element 1121 when viewed from an upper surface of the insulating substrate 1110.

The heater structure 1100 may be rolled such that both ends of each of conductive tracks are close to each other. The rolled heater structure 800 may surround the aerosol generating substrate. The aerosol generating substrate may be inserted from the second heating element 1122 toward the first heating element 1121, and a control unit may independently control the first heating element 1121 and the second heating element 1122.

On the other hand, when both the first heating element 1121 and the second heating element 1122 are configured as conductive tracks, both the conductive tracks may not be densely disposed in only any one layer due to interference (e.g., a short circuit) between both the conductive tracks. On the other hand, in the heater structure 1100 of the present disclosure, some of conductive tracks are disposed by changing layers to prevent electrical contact, thereby increasing a heating density while preventing the interference between the first conductive track and the second conductive track.

FIG. 12 is a diagram illustrating a heater structure according to another embodiment of the present disclosure.

Referring to FIG. 12, a heater structure 1200 includes an insulating substrate 1210 including a plurality of layers 1211 and 1212 and a plurality of heating elements 1221 and 1230. The heater structure 1200 may be a configuration corresponding to the heater 18 of FIGS. 1 to 6. FIG. 12 is different from FIGS. 7 to 10 in that the insulating substrate 1210 includes the plurality of layers, and some of the plurality of heating elements (e.g., conductive tracks) are disposed by changing the plurality of layers so as not to overlap each other. In addition, FIG. 12 is different from FIG. 11 in that the heating element 1221 is configured as a graphene heating element.

The insulating substrate 1210 may include a first layer 1211 and a second layer 1212 and may perform an electrical insulating function. According to an embodiment, the insulating substrate 1210 may simultaneously perform a thermally conductive function of conducting heat emitted from the plurality of heating elements 1221 and 1230.

The plurality of heating elements 1221 and 1230 may include a first heating element 1221 and a second heating element 1230. The first heating element 1221 may be configured as the graphene heating element, and the second heating element 1230 may be configured as a conductive track. The first heating element 1221 may be disposed in a first region 1213 of a first layer, and the second heating element 1230 may be disposed in a second region 1214 different from the first region 1213. The first region 1213 may refer to a region in one direction with respect to a center line in a longitudinal direction when the insulating substrate 1210 is viewed from an upper surface. The second region 1214 may refer to a region in the other direction with respect to the center line in the longitudinal direction.

The first heating element 1221 may include a first electrode 1221a, a second electrode 1221b, and a graphene element 1221c between the first electrode 1221a and the second electrode 1221b. The first electrode 1221a and the second electrode 1221b may include electrically conductive materials, and may be connected to a battery. As power is supplied to the first electrode 1221a and the second electrode 1221b, the graphene element 1221c may generate heat to heat an aerosol generating substrate.

The second heating element 1230 includes a first conductive track 1231 and a second conductive track 1232. Each of the first conductive track 1231 and the second conductive track 1232 includes an electrically resistive material, and both ends thereof may be electrically connected to the battery. Each of the first conductive track 1231 and the second conductive track 1232 may generate heat by the power supplied from the battery to heat the aerosol generating substrate. The arrangement of the first conductive track 1231 and the second conductive track 1232 included in the second heating element 1230 is as shown in FIG. 11. In other words, the first conductive track 1231 may be disposed in the first layer 1211, and a part of the second conductive track 1232 may be disposed in the second layer 1212 so that the second conductive track 1232 does not electrically contact the first conductive track 1231. The arrangement of the first conductive track 1231 and the second conductive track 1232 is referred to FIG. 11.

The heater structure 1200 may be rolled such that both ends of the conductive track and both electrodes of the graphene heating element are close to each other. The rolled heater structure 1200 may surround the aerosol generating substrate. The aerosol generating substrate may be inserted from the conductive track toward the graphene heating element, and a control unit may independently control the conductive track and the graphene heating element.

Meanwhile, the heater structure 1200 of FIG. 12 has the advantages of FIGS. 8 and 11. In other words, the graphene heating element is disposed in the lower portion of the aerosol generating substrate, and thus the heater structure 1200 may increase heating efficiency due to surface heat generation and reducing power consumption. In addition, the first conductive track 1231 and the second conductive track 1232 may be densely disposed in the heater structure 1200 while preventing interference between the first conductive track 1231 and the second conductive track 1232.

FIG. 13 is a diagram illustrating a temperature profile of a heater structure according to an embodiment of the present disclosure.

Referring to FIG. 13, a microprocessor may control power supplied to a plurality of heating elements. The microprocessor may be the control unit 12 of FIGS. 1 to 6. In addition, the plurality of heating elements may be the heating elements 721, 722, 821, 822, 921, 922, 1021, 1022, 1121, 1122, 1221, and 1230 of FIGS. 7 to 12. The control unit 12 controls power supplied to the plurality of heating elements that are not in electrical contact with each other based on a preset temperature profile.

The control unit 12 controls the power supplied to the first heating element 721, 821, 921, 1021, 1121, or 1221 (hereinafter referred to as 721, when there is no need for further classification) based on a first temperature profile 1310. In addition, the control unit 12 controls the power supplied to the second heating element 722, 822, 922, 1022, 1122, 1230, (hereinafter referred to as 722, when there is no need for further classification) based on a second temperature profile 1320. While the control unit 12 starts power supply to the first heating element 721, the control unit 12 may start power supply to the second heating element 722 after a preset time. When the control unit 12 starts power supply to the second heating element 722, the control unit 12 starts power supply to the second heating element 722 according to the same target temperature as a target temperature of the first heating element 721. The preset time may be the same as a preheating completion time of the first heating element 721. For example, the preset time may be 40 seconds, but is not limited thereto.

The control unit 12 may control power supplied to the first heating element 721 based on a first target temperature Te1 for a first time T1. The temperature of the first heating element 721 may reach the first target temperature Te1 within the first time T1. For example, the first time T1 may be 40 seconds, and the first target temperature Te1 may be any one temperature selected from 270 degrees to 290 degrees.

The control unit 12 may control power supplied to the first heating element 721 according to a second target temperature Te2 lower than the first target temperature Te1 for a second time T2 after the first time T1. For example, the second time T2 may be 3 minutes, and the second target temperature Te2 may be any one temperature selected from 240 degrees to 260 degrees.

The control unit 12 may control power supplied to the first heating element 721 according to a third target temperature Te3 lower than the second target temperature Te2 for a third time T3 after the second time T2. For example, the third time T3 may be 40 seconds, and the third target temperature Te3 may be any one temperature selected from 235 degrees to 240 degrees.

The control unit 12 may control power supplied to the first heating element 721 according to a fourth target temperature Te4 lower than the third target temperature Te3 for a fourth time T4 after the fourth time T3 and cut off the power supplied to the first heating element 721 after the fourth time T4. For example, the fourth time T4 may be 40 seconds, and the fourth target temperature Te4 may be any one temperature selected from 220 degrees to 235 degrees.

After starting power supply to the second heating element 722 after the first time T1, and starting power supply to the second heating element 722, the control unit 12 may control power supplied to the second heating element 722 according to the same target temperature as the target temperature of the first heating element 721. In other words, the control unit 12 may control power supplied to the second heating element 722 according to the second target temperature Te2 for the second time T2, control power supplied to the second heating element 722 according to the third target temperature Te3 for the third time T3, and control power supplied to the second heating element 722 according to the fourth target temperature Te4 for the fourth time T4.

Meanwhile, a substrate detection unit may identify a type of an aerosol generating substrate accommodated in a cavity, and the control unit 12 may change a heating time, a target temperature, and a power supply start time of the second heating element 722 according to the identified aerosol generating substrate. A substrate detection function may be performed by an insertion detection sensor 133 of FIG. 15. The aerosol generating device 1 of the present disclosure independently controls a plurality of heating elements according to the type of the aerosol generating substrate, and thus a transfer amount of the aerosol generating substrate is increased, thereby providing the optimal flavor experience. In addition, the aerosol generating device 1 preheats the aerosol generating substrate by using only one heating element at the beginning of heating, and heats the aerosol generating substrate by using all of a plurality of heating elements after preheating, and thus the transfer amount of the aerosol generating substrate continues until the latter part of heating. Therefore, there is an advantage that the flavor experience is maintained until the latter part of heating.

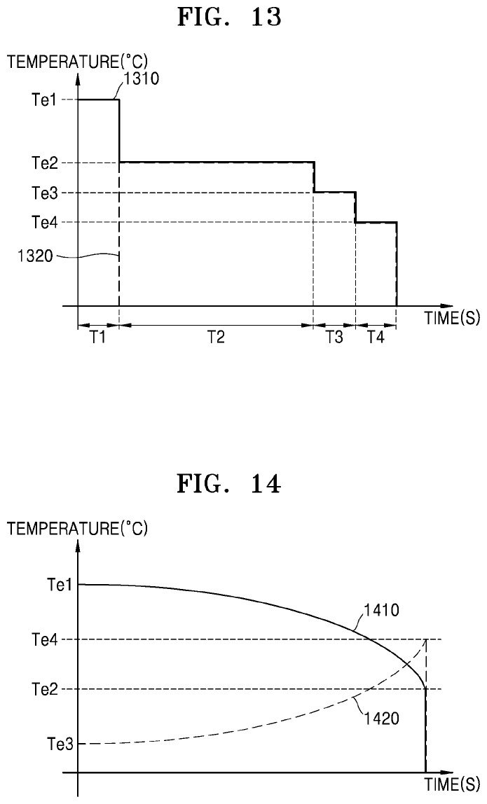

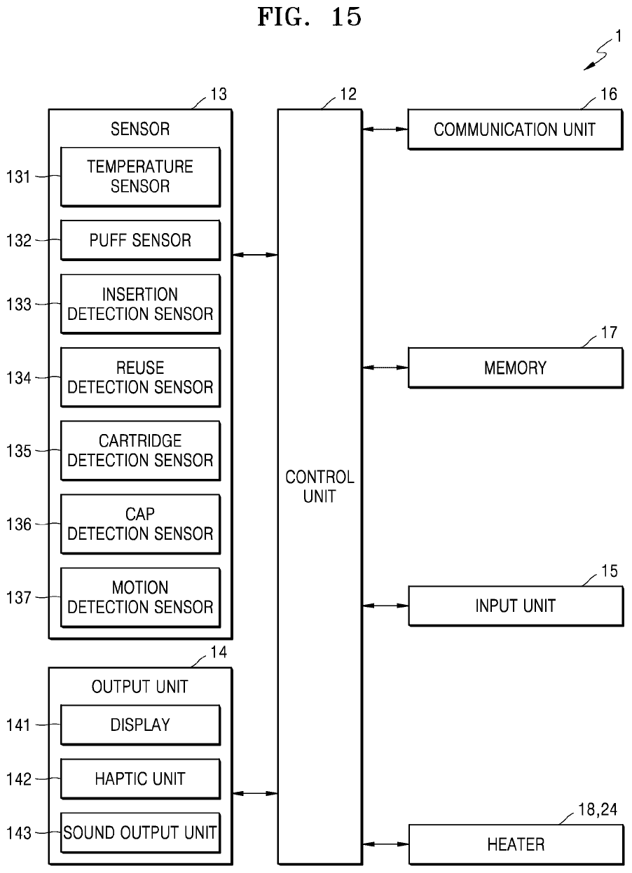

FIG. 14 is a diagram illustrating a temperature profile of a heater structure according to another embodiment of the present disclosure. FIG. 14 is different from FIG. 13 in that power supply to a first heating element and a second heating element starts at the same time.

Referring to FIG. 14, a microprocessor may control power supplied to a plurality of heating elements. The microprocessor may be the control unit 12 of FIGS. 1 to 6. In addition, the plurality of heating elements may be the heating elements 721, 722, 821, 822, 921, 922, 1021, 1022, 1121, 1122, 1221, and 1230 of FIGS. 7 to 12. The control unit 12 controls power supplied to the plurality of heating elements that are not in electrical contact with each other based on a preset temperature profile.

The control unit 12 controls power supplied to the first heating element 721 based on a first temperature profile 1410. In addition, the control unit 12 controls power supplied to the second heating element 722 based on a second temperature profile 1420. The first temperature profile 1410 and the second temperature profile 1420 may be different from each other. In an embodiment, the first temperature profile 1410 may gradually increase with increasing time. The second temperature profile 1420 may gradually decrease with increasing time.

The first temperature profile 1410 may decrease from the first target temperature Te1 to the second target temperature Te2. The second temperature profile 1420 may increase from the third target temperature Te3 to the fourth target temperature Te4. The first temperature profile 1410 and the second temperature profile 1420 may be symmetrical to each other with respect to an x-axis. In other words, the second temperature profile 1420 may compensate for a temperature decrease of the first temperature profile 1410.

On the other hand, the second temperature profile 1420 of the second heating element 722 gradually increases or decreases, and thus the aerosol generating device 1 of the present disclosure has the advantage of continuing a transfer amount of an aerosol generating substrate until the latter part of heating. In addition, temperature profiles of the plurality of heating elements are complementary to each other, and thus the aerosol generating device 1 of the present disclosure may provide a uniform flavor experience throughout the heating period.

FIG. 15 is a block diagram of an aerosol generating device according to an embodiment of the present disclosure.

The aerosol generating device 1 may include the power source 11, the control unit 12, the sensor 13, an output unit 14, an input unit 15, a communication unit 16, a memory 17, and at least one heater 18 and 24. However, an internal structure of the aerosol generating device 1 is not limited to that shown in FIG. 15. In other words, according to the design of the aerosol generating device 1, one of ordinary skill in the art related to the present embodiment that some of the components shown in FIG. 15 may be omitted or new components may be added.

The sensor 13 may detect a state of the aerosol generating device 1 or a state around the aerosol generating device 1 and transmit detected information to the control unit 12. Based on the detected information, the control unit 12 may control the aerosol generating device 1 to perform various functions such as control of operations of the cartridge heater 24 and/or the heater 18, a restriction on smoking, determination of whether the aerosol generating article S and/or the cartridge 19 are inserted, and a notification display.

The sensor 13 may include at least one of a temperature sensor 131, a puff sensor 132, the insertion detection sensor 133, a reuse detection sensor 134, a cartridge detection sensor 135, a cap detection sensor 136, or a movement detection sensor 137.

The temperature sensor 131 may detect a temperature at which the cartridge heater 24 and/or the heater 18 are heated. The aerosol generating device 1 may include a separate temperature sensor for detecting the temperatures of the cartridge heater 24 and/or the heater 18, or the cartridge heater 24 and/or the heater 18 may operate as temperature sensors.

The temperature sensor 131 may output a signal corresponding to the temperature of the cartridge heater 24 and/or the heater 18. For example, the temperature sensor 131 may include a resistor element whose resistance value changes in correspondence to a change in the temperature of the cartridge heater 24 and/or the heater 18. The temperature sensor 131 may be implemented by a thermistor, etc., which is an element using a property of changing resistance according to temperature. Here, the temperature sensor 131 may output a signal corresponding to the resistance value of the resistor element as a signal corresponding to the temperature of the cartridge heater 24 and/or the heater 18. For example, the temperature sensor 131 may include a sensor that detects a resistance value of the cartridge heater 24 and/or the heater 18. Here, the temperature sensor 131 may output a signal corresponding to the resistance value of the cartridge heater 24 and/or the heater 18 as a signal corresponding to the temperature of the cartridge heater 24 and/or the heater 18.

The temperature sensor 131 may be disposed around the power source 11 to monitor a temperature of the power source 11. The temperature sensor 131 may be disposed adjacent to the power source 11. For example, the temperature sensor 131 may be attached to one surface of a battery that is the power source 11. For example, the temperature sensor 131 may be mounted on one surface of a PCB.

The temperature sensor 131 may be disposed inside the body 10 to detect an internal temperature of the body 10.

The puff sensor 132 may detect a puff by a user based on various physical changes in an air flow path. The puff sensor 132 may output a signal corresponding to the puff. For example, the puff sensor 132 may be a pressure sensor. The puff sensor 132 may output a signal corresponding to internal pressure of the aerosol generating device 1. Here, the internal pressure of the aerosol generating device 1 may correspond to pressure of the air flow path through which a gas flows. The puff sensor 132 may be disposed in correspondence to the air flow path through which the gas flows in the aerosol generating device 1.

The insertion detection sensor 133 may detect insertion and/or removal of the aerosol generating article S. The insertion detection sensor 133 may detect a signal change due to the insertion and/or removal of the aerosol generating article S. The insertion detection sensor 133 may be installed around an insertion space. The insertion detection sensor 133 may detect the insertion and/or removal of the aerosol generating article S according to a change in a dielectric constant inside the insertion space. For example, the insertion detection sensor 133 may be an inductive sensor and/or a capacitance sensor.

The inductive sensor may include at least one coil. The coil of the inductive sensor may be disposed adjacent to the insertion space. For example, when a magnetic field changes around the coil through which a current flows, characteristics of the current flowing through the coil may change according to Faraday's law of electromagnetic induction. Here, the characteristics of the current flowing through the coil may include a frequency of an alternating current, a current value, a voltage value, an inductance value, an impedance value, etc.

The inductive sensor may output a signal corresponding to the characteristics of the current flowing through the coil. For example, the inductive sensor may output a signal corresponding to an inductance value of the coil.

The capacitance sensor may include a conductor. The conductor of the capacitance sensor may be disposed adjacent to the insertion space. The capacitance sensor may output a signal corresponding to an ambient electromagnetic characteristic, e.g., a capacitance around the conductor. For example, when the aerosol generating article S including a metal wrapper is inserted into the insertion space, the electromagnetic characteristic around the conductor may be changed by the wrapper of the aerosol generating article S.

The reuse detection sensor 134 may detect whether the aerosol generating article S is reused. The reuse detection sensor 134 may be a color sensor. The color sensor may detect a color of the aerosol generating article S. The color sensor may detect a color of a part of the wrapper wrapping the outside of the aerosol generating article S. The color sensor may detect a value for an optical characteristic corresponding to a color of an object, based on light reflected from the object. For example, the optical characteristic may be a wavelength of light. The color sensor may be implemented as a single component with a proximity sensor or may be implemented as a separate component distinguished from the proximity sensor.

At least a part of the wrapper constituting the aerosol generating article S may have a color changing by an aerosol. When the aerosol generating article S is inserted into the insertion space, the reuse detection sensor 134 may be disposed in correspondence to a position at which at least the part of the wrapper whose color changes by the aerosol is disposed. For example, before the aerosol generating article S is used by the user, the color of at least the part of the wrapper may be a first color. Here, when at least a part of the wrapper is wetted by the aerosol while the aerosol generated by the aerosol generating device 1 passes through the aerosol generating article S, the color of at least the part of the wrapper may be changed to a second color. The color of at least the part of the wrapper may be maintained in the second color after changing from the first color to the second color.

The cartridge detection sensor 135 may detect mounting and/or removal of the cartridge 19. The cartridge detection sensor 135 may be implemented by an inductance-based sensor, a capacitive sensor, a resistance sensor, a hall sensor (a hall IC) using a hall effect, etc.

The cap detection sensor 136 may detect mounting and/or removal of a cap. When the cap is detached from the body 10, a part of the cartridge 19 and the body 10 covered by the cap may be exposed to the outside. The cap detection sensor 136 may be implemented by a contact sensor, a hall sensor (a hall IC), an optical sensor, etc.

The movement detection sensor 137 may detect a movement of the aerosol generating device 1. The movement detection sensor 137 may be implemented as at least one of an acceleration sensor or a gyro sensor.

In addition to the sensors 131 to 137 described above, the sensor 13 may further include at least one of a humidity sensor, an atmospheric pressure sensor, a magnetic sensor, a position sensor (e.g., a global positioning system (GPS)), or a proximity sensor. Functions of the respective sensors may be intuitively inferred from names thereof by one of ordinary skill in the art, and thus, detailed descriptions thereof may be omitted.

The output unit 14 may output information about the state of the aerosol generating device 1 and provide the information to the user. The output unit 14 may include at least one of a display 141, a haptic unit 142, or a sound output unit 143, but is not limited thereto. When the display 141 and a touch pad form a layer structure to form a touch screen, the display 141 may be used as an input device in addition to an output device.

The display 141 may visually provide the user with information about the aerosol generating device 1. For example, the information about the aerosol generating device 1 may refer to various types of information such as a charging/discharging state of the power source 11 of the aerosol generating device 1, a preheating state of the heater 18, the insertion/removal state of the aerosol generating article S and/or the cartridge 19, the mounting/removal state of the cap, and the restriction on use of the aerosol generating device 1 (e.g., detection of an abnormal article), and the display 141 may output the information to the outside. For example, the display 141 may be in the form of a light emitting diode (LED) light emitting device. For example, the display 141 may be a liquid crystal display (LCD) panel, an organic light emitting display (OLED) panel, etc.

The haptic unit 142 may tactilely provide the user with the information about the aerosol generating device 1 by converting an electrical signal into a mechanical stimulus or an electrical stimulus. For example, when initial power is supplied to the cartridge heater 24 and/or the heater 18 for a set time, the haptic unit 142 may generate vibration corresponding to completion of initial preheating. The haptic unit 142 may include a vibration motor, a piezoelectric element, or an electrical stimulation device.

The sound output unit 143 may audibly provide the user with the information about the aerosol generating device 1. For example, the sound output unit 143 may convert the electrical signal into a sound signal and output the sound signal to the outside.

The power supply 11 may supply power used to operate the aerosol generating device 1. The power source 11 may supply power so that the cartridge heater 24 and/or the heater 18 may be heated. In addition, the power source 11 may supply power needed for operations of the sensor 13, the output unit 14, the input unit 15, the communication unit 16, and the memory 17, which are other components provided within the aerosol generating device 1. The power source 11 may be a rechargeable battery or a disposable battery. For example, the power supply 11 may be a lithium polymer (LiPoly) battery, but is not limited thereto.

Although not shown in FIG. 15, the aerosol generating device 1 may further include a power protection circuit. The power protection circuit may be electrically connected to the power source 11 and may include a switching element.

The power protection circuit may cut off an electrical path with respect to the power source 11 according to a certain condition. For example, the power protection circuit may cut off the electrical path with respect to the power source 11 when a voltage level of the power source 11 is a first voltage or more corresponding to overcharging. For example, the power protection circuit may cut off the electrical path with respect to the power source 11 when the voltage level of the power source 11 is less than a second voltage corresponding to over discharging.

The heater 18 may be supplied with power from the power source 11 and heat a medium or an aerosol generating material within the aerosol generating article S. Although not shown in FIG. 15, the aerosol generating device 1 may further include a power conversion circuit (e.g., a DC/DC converter) that converts power of the power source 11 and supplies the converted power to the cartridge heater 24 and/or the heater 18. In addition, when the aerosol generating device 1 generates an aerosol by an induction heating method, the aerosol generating device 1 may further include a DC/AC converter that converts DC power of the power source 11 into AC power.

The control unit 12, the sensor 13, the output unit 14, the input unit 15, the communication unit 16, and the memory 17 may be supplied with power from the power source 11 to perform functions. Although not shown in FIG. 15, the aerosol generating device 1 may further include a power conversion circuit that converts power of the power source 11 and supplies the power to each of components, e.g., a low-dropout (LDO) circuit or a voltage regulator circuit. In addition, although not shown in FIG. 15, a noise filter may be provided between the power source 11 and the heater 18. The noise filter may be a low pass filter. The low pass filter may include at least one inductor and a capacitor. A cutoff frequency of the low pass filter may correspond to a frequency of a high-frequency switching current applied from the power source 11 to the heater 18. The low pass filter may prevent a high-frequency noise component from being applied to the sensor 13, such as the insertion detection sensor 133.

In an embodiment, the cartridge heater 24 and/or the heater 18 may include any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. In addition, the heater 18 may be implemented by a metal wire, a metal plate on which the track 242 track is disposed, or a ceramic heating element, but is not limited thereto.

The input unit 15 may receive information input from the user or output the information to the user. For example, the input unit 15 may be a touch panel. The touch panel may include at least one touch sensor detecting a touch. For example, the touch sensor may include a capacitive touch sensor, a resistive touch sensor, a surface acoustic touch sensor, an infrared touch sensor, etc., but is not limited thereto.

The display 141 and the touch panel may be implemented as one panel. For example, the touch panel may be inserted into the display 141 (e.g., may be an on-cell type or in-cell type). For example, the touch panel may be added on the display 141 (e.g., may be an add-on type).

Meanwhile, the input unit 15 may include a button, a keypad, a dome switch, a jog wheel, a jog switch, etc., but is not limited thereto.

The memory 17 may be hardware storing various types of data processed within the aerosol generating device 1 and may store pieces of data processed by the control unit 12 and pieces of data to be processed by the control unit 12. The memory 17 may include at least one type of storage medium from among a flash memory type, a hard disk type, a multimedia card micro type, a card type memory (e.g., a SD or XD memory or the like), random access memory (RAM), static random access memory (SRAM), read-only memory (ROM), electrically erasable programmable read-only memory (EEPROM), programmable read-only memory (PROM), a magnetic memory, a magnetic disk, or an optical disk. The memory 17 may store data regarding an operation time of the aerosol generating device 1, the maximum number of puffs, the current number of puffs, at least one temperature profile, a smoking pattern of the user, etc.

The communication unit 16 may include at least one component for communication with another electronic device. For example, the communication unit 16 may include at least one of a short-range wireless communication unit or a wireless communication unit.

The short-range wireless communication unit may include a Bluetooth communication unit, a Bluetooth low energy (BLE) communication unit, a near field communication unit, a wireless local area network ((WLAN) (Wi-Fi)) communication unit, a Zigbee communication unit, an infrared data association (IrDA) communication unit, a Wi-Fi Direct (WFD) communication unit, an ultra wideband (UWB) communication unit, an Ant+communication unit, etc., but is not limited thereto.

The wireless communication unit may include a cellular network communication unit, an Internet communication unit, a computer network (e.g., LAN or WAN) communication unit, etc., but is not limited thereto.

Although not shown in FIG. 15, the aerosol generating device 1 may further include a connection interface such as a universal serial bus (USB) interface, and may connect with another external device through the connection interface such as a USB interface to transmit and receive information or charge the power 11.

The control unit 12 may control an overall operation of the aerosol generating device 1. In an embodiment, the control unit 12 may include at least one processor. The processor may be implemented as an array of a plurality of logic gates or may be implemented as a combination of a general-purpose microprocessor and a memory that stores a program executable by the microprocessor. In addition, one of ordinary skill in the art to which the present embodiment pertains may understand that the processor may be implemented as other types of hardware.

The control unit 12 may control the temperature of the heater 18 by controlling supply power from the power source 11 to the heater 18. The control unit 12 may control the temperature of the cartridge heater 24 and/or the heater 18 based on the temperature of the cartridge heater 24 and/or the heater 18 sensed by the temperature sensor 131. The control unit 12 may adjust power supplied to the cartridge heater 24 and/or the heater 18, based on the temperature of the cartridge heater 24 and/or the heater 18. For example, the control unit 12 may determine a target temperature for the cartridge heater 24 and/or the heater 18, based on a temperature profile stored in the memory 17.

The aerosol generating device 1 may include a power supply circuit (not shown) electrically connected to the power source 11 between the power source 11 and the cartridge heater 24 and/or the heater 18. The power supply circuit may be electrically connected to the cartridge heater 24 or the heater 18. The power supply circuit may include at least one switching element. The switching element may be implemented by a bipolar junction transistor (BJT), a field effective transistor (FET), etc. The control unit 12 may control the power supply circuit.

The control unit 12 may control power supply by controlling switching of the switching element of the power supply circuit. The power supply circuit may be an inverter that converts DC power output from the power source 11 into AC power. For example, the inverter may include a full-bridge circuit or a half-bridge circuit including a plurality of switching elements.

The control unit 12 may turn on the switching element such that power is supplied from the power source 11 to the cartridge heater 24 and/or the heater 18. The control unit 12 may turn off the switching element to cut off the supply of power to the cartridge heater 24 and/or the heater 18. The control unit 12 may adjust a current supplied from the power source 11 by adjusting a frequency and/or duty ratio of a current pulse input into the switching element.

The control unit 12 may control a voltage output from the power source 11 by controlling switching of the switching element of the power supply circuit. The power conversion circuit may convert the voltage output from the power source 11. For example, the power conversion circuit may include a buck-converter that steps down the voltage output from the power source 11. For example, the power conversion circuit may be implemented through a buck-boost converter, a zener diode, etc.

The control unit 12 may adjust a level of the voltage output from the power conversion circuit by controlling an on/off operation of the switching element included in the power conversion circuit. When the switching element continues to be turned on, the level of the voltage output from the power conversion circuit may correspond to a level of a voltage output from the power source 11. The duty ratio of the on/off operation of the switching element may correspond to a ratio of the voltage output from the power conversion circuit to the voltage output from the power source 11. The level of the voltage output from the power conversion circuit may decrease with a decrease in the duty ratio of the on/off operation of the switching element. The heater 18 may be heated based on the voltage output from the power conversion circuit.

The control unit 12 may control power to be supplied to the heater 18 by using at least one of a pulse width modulation (PWM) method or a proportional-integral-differential (PID) method. For example, the control unit 12 may control a current pulse having a certain frequency and duty ratio to be supplied to the heater 18 by using the PWM method. The control unit 12 may control the power supplied to the heater 18 by adjusting the frequency and duty ratio of the current pulse.

For example, the control unit 12 may determine a target temperature to be controlled, based on the temperature profile. The control unit 12 may control the power supplied to the heater 18 by using the PID method, which is a feedback control method through a difference value between the temperature of the heater 18 and the target temperature, a value obtained by integrating the difference value over time, and a value obtained by differentiating the difference value over time.

The control unit 12 may prevent the cartridge heater 24 and/or the heater 18 from overheating. For example, based on the fact that the temperature of the cartridge heater 24 and/or the heater 18 exceeds a preset limit temperature, the control unit 12 may control an operation of the power conversion circuit so that the supply of power to the cartridge heater 24 and/or the heater 18 stops. For example, based on the fact that the temperature of the cartridge heater 24 and/or the heater 18 exceeds the preset limit temperature, the control unit 12 may reduce an amount of power supplied to the cartridge heater 24 and/or the heater 18 by a certain ratio. For example, based on the fact that the temperature of the cartridge heater 24 exceeds the preset limit temperature, the control unit 12 may determine that the aerosol generating material accommodated in the cartridge 19 is exhausted and cut off the power supply to the cartridge heater 24.

The control unit 12 may control charging and discharging of the power source 11. The control unit 12 may identify the temperature of the power source 11 based on an output signal of the temperature sensor 131.

When a power line is connected to a battery terminal of the aerosol generating device 1, the control unit 12 may identify whether the temperature of the power source 11 is a first limit temperature or more which is a reference for blocking charging of the power source 11. When the temperature of the power source 11 is less than the first limit temperature, the control unit 12 may control the power source 11 to be charged, based on a preset charging current. The control unit 12 may block charging of the power source 11 when the temperature of the power source 11 is the first limit temperature or more.

While the power of the aerosol generating device 1 is turned on, the control unit 12 may identify whether the temperature of the power source 11 is a second limit temperature or more which is a reference for blocking discharge of the power source 11. The control unit 12 may control power stored in the power source 11 to be used when the temperature of the power source 11 is less than the second limit temperature. When the temperature of the power source 11 is the second limit temperature or more, the control unit 12 may stop using the power stored in the power source 11.

The control unit 12 may calculate the remaining capacity of the power stored in the power source 11. For example, the control unit 12 may calculate the remaining capacity of the power source 11 based on a voltage and/or current sensing value of the power source 11.

The control unit 12 may determine, through the insertion detection sensor 133, whether the aerosol generating article S is inserted into the insertion space. The control unit 12 may determine that the aerosol generating article S is inserted, based on the output signal of the insertion detection sensor 133. When determining that the aerosol generating article S is inserted into the insertion space, the control unit 12 may control power to be supplied to the cartridge heater 24 and/or the heater 18. For example, the control unit 12 may supply power to the cartridge heater 24 and/or the heater 18, based on the temperature profile stored in the memory 17.

The control unit 12 may determine whether aerosol generating article S is removed from the insertion space. For example, the control unit 12 may determine, through the insertion detection sensor 133, whether aerosol generating article S is removed from the insertion space. For example, when the temperature of the heater 18 is the preset limit temperature or more or when a temperature change gradient of the heater 18 is a set gradient, the control unit 12 may determine that the aerosol generating article S is removed from the insertion space. When determining that the aerosol generating article S is removed from the insertion space, the control unit 12 may cut off the supply of power to the cartridge heater 24 and/or the heater 18.

The control unit 12 may control a power supply time and/or a power supply amount with respect to the heater 18, according to a state of the aerosol generating article S detected by the sensor 13. The control unit 12 may identify, based on a look-up table, a level range including a level of a signal of the capacitance sensor. The control unit 12 may determine an amount of moisture in the aerosol generating article S, according to the identified level range.

When the aerosol generating article S is in an over-moisture state, the control unit 12 may increase a preheating time of the aerosol generating article S compared to a normal state by controlling the power supply time with respect to the heater 18.

The control unit 12 may determine, through the reuse detection sensor 134, whether aerosol generating article S inserted into the insertion space is reused. For example, the control unit 12 may compare a sensing value of a signal of the reuse detection sensor 134 with a first reference range including a first color and when the sensing value is included in the first reference range, determine that the aerosol generating article S is not used. For example, the control unit 12 may compare the sensing value of the signal of the reuse detection sensor 134 with a second reference range including a second color and when the sensing value is included in the second reference range, determine that the aerosol generating article S is used. When it is determined that the aerosol generating article S is used, the control unit 12 may cut off the supply of power to the cartridge heater 24 and/or the heater 18.

The control unit 12 may determine, through the cartridge detection sensor 135, whether the cartridge 19 is coupled and/or removed. For example, the control unit 12 may determine whether the cartridge 19 is coupled or removed, based on a sensing value of the signal of the cartridge detection sensor 135.

The control unit 12 may determine whether the aerosol generating material of the cartridge 19 is exhausted. For example, the control unit 12 may apply power to preheat the cartridge heater 24 and/or the heater 18, determine whether the temperature of the cartridge heater 24 exceeds the limit temperature in a preheating period, and when the temperature of the cartridge heater 24 exceeds the limit temperature, determine that the aerosol generating material of the cartridge 19 is exhausted. When it is determined that the aerosol generating material of the cartridge 19 is exhausted, the control unit 12 may cut off the supply of power to the cartridge heater 24 and/or the heater 18.

The control unit 12 may determine whether the cartridge 19 may be usable. When the current number of puffs is greater than or equal to the maximum number of puffs set in the cartridge 19, the control unit 12 may determine, based on data stored in the memory 17, that the cartridge 19 may not be usable. For example, when the total time for which the heater 24 is heated is a preset maximum time or more or the total amount of power supplied to the heater 24 is a preset maximum amount of power or more, the control unit 12 may determine that the cartridge 19 may not be usable.

The control unit 12 may determine inhalation by the user through the puff sensor 132. For example, the control unit 12 may determine whether a puff occurs, based on a sensing value of a signal of the puff sensor 132. For example, the control unit 12 may determine an intensity of the puff, based on the sensing value of the signal of the puff sensor 132. When the number of puffs reaches the preset maximum number of puffs or when puffs are not detected for a preset time or more, the control unit 12 may cut off the supply of power to the cartridge heater 24 and/or the heater 18.

The control unit 12 may determine, through the cap detection sensor 136, whether a cap is coupled and/or removed. For example, the control unit 12 may determine whether the cap is coupled and/or removed, based on a sensing value of a signal of the cap detection sensor 136.

The control unit 12 may control the output unit 14 based on the result detected by the sensor 13. For example, when the number of puffs counted through the puff sensor 132 reaches a preset number, the control unit 12 may notify the user that the aerosol generating device 1 soon ends, through at least one of the display 141, the haptic unit 142, or the sound output unit 143. For example, the control unit 12 may notify the user through the output unit 14 that the aerosol generating article S is not present in the insertion space, based on the determination that the aerosol generating article S is not present in the insertion space. For example, the control unit 12 may notify the user through the output unit 14 that the cartridge 19 and/or the cap are not mounted, based on the determination that the cartridge 19 and/or the cap are not mounted. For example, the control unit 12 may transmit information about the temperature of the cartridge heater 24 and/or the heater 18 to the user through the output unit 14.

The control unit 12 may store and update, in the memory 17, a history of a certain event that occurs, based on the occurrence of the event. The event may include detection of insertion of the aerosol generating article S, initiation of heating of the aerosol generating article S, detection of puffs, termination of the puffs, detection of overheating of the cartridge heater 24 and/or the heater 18, detection of application of an overvoltage to the cartridge heater 24 and/or the heater 18, termination of heating of the aerosol generating article S, an operation such as power on/off of the aerosol generating device 1, initiation of charging of the power source 11, detection of overcharging of the power source 11, termination of charging of the power source 11, etc. The history of the event may include a date and time when the event has occurred, log data corresponding to the event, etc. For example, when the certain event is the detection of insertion of the aerosol generating article S, the log data corresponding to the event may include data of the sensing value of the insertion detection sensor 133, etc. For example, when the certain event is the detection of overheating of the cartridge heater 24 and/or the heater 18, the log data corresponding to the event may include data of the temperature of the cartridge heater 24 and/or the heater 18, the voltage applied to the cartridge heater 24 and/or the heater 18, a current flowing through the cartridge heater 24 and/or the heater 18, etc.

The control unit 12 may control to form a communication link with an external device such as a mobile terminal of the user. When data of authentication is received from the external device through the communication link, the control unit 12 may release a restriction on use of at least one function of the aerosol generating device 1. Here, the data of the authentication may include data indicating completion of user authentication with respect to the user corresponding to the external device. The user may perform the user authentication through the external device. The external device may determine whether user data is valid, based on the birthday of the user, a unique number indicating the user, etc. and receive, from an external server, data of use authority over the aerosol generating device 1. The external device may transmit the data indicating the completion of the user authentication to the aerosol generating device 1, based on the data of the use authority. When the user authentication is completed, the control unit 12 may release the restriction on the use of at least one function of the aerosol generating device 1. For example, when the user authentication is completed, the control unit 12 may release a restriction on use of a heating function of supplying power to the heater 18.

The control unit 12 may transmit data of the state of the aerosol generating device 1 to the external device through the communication link formed with the external device. Based on the received data of the state of the aerosol generating device 1, the external device may output the remaining capacity of the power source 11 of the aerosol generating device 1, an operation mode, etc. through a display of the external device.

The external device may transmit a location search request to the aerosol generating device 1, based on an input initiating a location search of the aerosol generating device 1. When receiving the location search request from the external device, the control unit 12 may control at least one of output devices to perform an operation corresponding to the location search, based on the received location search request. For example, the haptic unit 142 may generate vibration in response to the location search request. For example, the display 141 may output an object corresponding to the location search and an end of the search in response to the location search request.

When receiving firmware data from the external device, the control unit 12 may control to perform a firmware update. The external device may identify a current version of firmware of the aerosol generating device 1 and determine whether a new version of the firmware is present. When an input for requesting firmware download is received, the external device may receive a new version of firmware data and transmit the new version of firmware data to the aerosol generating device 1. As receiving the new version of firmware data, the control unit 12 may control the firmware update of the aerosol generating device 1 to be performed.

The control unit 12 may transmit data of a sensing value of at least one sensor 13 to the external server (not shown) through the communication unit 16, and receive, from the server, and store a learning model generated by learning the sensing value through machine learning such as deep learning. The control unit 12 may perform an operation of determining an inhalation pattern of the user, an operation of generating a temperature profile, etc. by using the learning model received from the server. The control unit 12 may store, in the memory 17, sensing value data of the at least one sensor 13, data for training an artificial neural network (ANN), etc. For example, the memory 17 may store a database of each component provided in the aerosol generating device 1, which is for training the ANN, and weights and biases constituting the structure of the ANN. The control unit 12 may generate at least one learning model used for determining the inhalation pattern of the user, generating the temperature profile, etc., by learning data of the sensing value of the at least one sensor 13, the inhalation pattern of the user, the temperature profile, etc. which are stored in the memory 17.

Some embodiments or other embodiments of the disclosure described above are not exclusive or distinct from each other. In some embodiments or other embodiments of the present disclosure described above, respective components or functions may be used in combination with one another or combined with one another.

For example, a component A described in a particular embodiment and/or drawing and a component B described in another embodiment and/or drawing may be combined with each other. In other words, even when coupling between components is not directly described, the coupling may be made except when the coupling is described as impossible.

The above description should not be construed as being limited in all respects but should be considered illustrative. The scope of the present disclosure should be determined by the logical interpretation of appended claims, and all changes within the equivalent scope of the disclosure are included in the scope of the present disclosure.

1. An aerosol generating device comprising:
a heater structure comprising an insulating substrate comprising at least one layer and a plurality of heating elements disposed in the at least one layer;
a battery configured to supply power to the plurality of heating elements; and
a control unit configured to independently control the power supplied to the plurality of heating elements.

2. The aerosol generating device of claim 1, wherein
the insulating substrate includes a first layer, and
the plurality of heating elements include a first heating element disposed in a first region of the first layer and a second heating element disposed in a second region of the first layer different from the first region.

3. The aerosol generating device of claim 2, wherein
the first heating element is a conductive track, and
the second heating element includes a first electrode, a second electrode, and a graphene element disposed between the first electrode and the second electrode.

4. The aerosol generating device of claim 2, wherein
the first heating element includes a first electrode, a second electrode, and a first graphene element disposed between the first electrode and the second electrode, and
the second heating element includes a third electrode, a fourth electrode, and a second graphene element disposed between the third electrode and the fourth electrode.

5. The aerosol generating device of claim 4, wherein
the first electrode, the second electrode, and the first graphene element are disposed on a first surface of the first layer, and
the third electrode, the fourth electrode, and the second graphene element are disposed in a second surface opposite to the first surface.

6. The aerosol generating device of claim 1, wherein
the insulating substrate includes a first layer and a second layer,
the plurality of heating elements include a first conductive track and a second conductive track,
the first conductive track is disposed in the first layer, and
a part of the second conductive track is disposed in the first layer, and another part of the second conductive track is disposed in the second layer.

7. The aerosol generating device of claim 6, wherein
the plurality of heating elements further include a first electrode, a second electrode, and a graphene element disposed between the first electrode and the second electrode,
the first conductive track and the second conductive track are disposed in a first region of the insulating substrate, and
the first electrode, the second electrode, and the graphene element are disposed in a second region of the insulating substrate different from the first region.

8. The aerosol generating device of claim 1, wherein
the plurality of heating elements include a first heating element and a second heating element that is not in electrical contact with the first heating element, and the control unit is configured to
start power supply to the second heating element after a preset time while starting power supply to the first heating element, and when starting power supply to the second heating elements, supply the power to the second heating element based on a second target temperature that is same as a first target temperature of the first heating element.

9. The aerosol generating device of claim 1, wherein
the plurality of heating elements include a first heating element and a second heating element that is not in electrical contact with the first heating element, and the control unit is configured to
start power supply to the first heating element and the second heating element at a same time, and when power supply is started, set a first temperature profile of the first heating element and a second temperature profile of the second heating element to be different from each other.

10. The aerosol generating device of claim 1, further comprising:
a substrate detection unit configured to identify a type of an aerosol generating substrate accommodated in a cavity.
